(19) United States
(12) Patent Application Publication
(10) Pub. No.: US 2015/0337759 A1
(43) Pub. Date: Nov. 26, 2015

(54) APPARATUS FOR GENERATING ENERGY

(71) Applicant: BECKER MARINE SYSTEMS GMBH & CO. KG, Hamburg (DE)

(72) Inventor: Dirk Lehmann, Winsen/Luhe (DE)

(73) Assignee: BECKER MARINE SYSTEMS GMBH & CO. KG, Hamburg (DE)

(21) Appl. No.: 14/760,058

(22) PCT Filed: Jan. 13, 2014
(86) PCT No.: PCT/EP2014/050512

§ 371 Date: Jul. 9, 2015

(30) Foreign Application Priority Data
Jan. 11, 2013 (DE) 20 2013 100 155.4
Feb. 25, 2013 (DE) 20 2013 100 814.1

(51) Int. Cl. F02G 5/02; B63B 35/44; H02J 4/00; F24H 9/20; F02B 63/04

(52) U.S. Cl. CPC F02G 5/02; F24H 9/2035; F02B 63/04; H02J 4/00; B63B 35/44; B63B 2035/4433; B63B 2035/444; B63B 2035/4453; B63B 2035/446; B63B 2035/4466

(57) ABSTRACT

In order to improve the adaptability of apparatuses for generating energy, which can be used to generate both electrical and thermal energy, to respective conditions of use with regard to the delivery of thermal energy to consumers, an apparatus for generating energy is stated and comprises:
a first energy generation unit for generating electrical energy, in particular power, and
a second energy generation unit for generating thermal energy, in particular heat and/or cold, and
a delivery device for delivering the thermal energy generated by the second energy generation unit to a consumer and a delivery regulation device, the delivery regulation device being designed to enable the delivery device in a first operating state and to block the delivery device in a second operating state, and/or
a control device for controlling the second energy generation unit, the control device being designed to activate the second energy generation unit in a first operating state and to block the second energy generation unit in a second operating state.

The invention relates to an apparatus for generating energy, comprising a first energy generation unit for generating electrical energy, in particular power, and a second energy generation unit for generating thermal energy, in particular heat and/or cold. The invention also relates to a buoyant energy supply apparatus comprising such an apparatus, to a system comprising a buoyant energy supply apparatus and to a method for supplying consumers with electrical energy and possibly with thermal energy using an apparatus for generating energy.

### PRIOR ART

Energy generation apparatuses comprising two separate energy generation units, each for generating energy of different energy types, are fundamentally known. For example, combined heat and power plants which can generate both power and heat using power-heat coupling and can deliver the obtained power or the obtained heat to the same load or to different loads are used in many places and for different purposes.

EP 2 092 177 B1 discloses an arrangement in which a power-generating generator is driven by an internal combustion engine which in turn obtains heat from the exhaust gases of the internal combustion engine using a heat-coupling device. These components are also arranged on a barge equipped with a buoyant hull.

Depending on the respective conditions of use of an apparatus for generating energy mentioned at the outset, it may be useful to deliver thermal energy to a consumer at a particular time and not to supply thermal energy at other times. For example, there may be times, locations or other circumstances for which the potential danger of thermal energy being misused by employees or other persons and being diverted to unintended consumers is relatively large. From an economical point of view, it may also be more profitable under given circumstances to not deliver any thermal energy to consumers at a particular time, at a particular location or under other circumstances for a certain period of time. This may be due to low prices to be achieved in comparison with the production costs or due to comparatively higher power prices, for example. In addition, it may be necessary to deliver thermal energy to consumers only at a particular location or at a particular time for reasons of the operational reliability of the apparatus.

### PRESENTATION OF THE INVENTION

### Object, Solution, Advantages

Therefore, the invention is based on the object of improving the adaptability of apparatuses for generating energy, which can be used to generate both electrical and thermal energy, to respective conditions of use with regard to the delivery of thermal energy to consumers.

In a first aspect, the invention relates to an apparatus for generating energy, which apparatus comprises the following components:

a first energy generation unit for generating electrical energy, in particular power, and

a second energy generation unit for generating thermal energy, in particular heat and/or cold, and

a delivery device for delivering the thermal energy generated by the second energy generation unit to a consumer and a delivery regulation device, and/or

a control device.

The delivery regulation device is also designed to enable the delivery device in a first operating state and to block the delivery device in a second operating state.

The control device is also provided for the purpose of controlling the second energy generation unit, the control device being designed to activate the second energy generation unit in a first operating state and to block or deactivate the second energy generation unit in a second operating state.

The delivery device is used to transmit the generated thermal energy to a consumer ready to receive the thermal energy. In the simplest case, the delivery device may therefore be a pipe or another line element in which thermal energy in the form of heated fluid, for example heated water, can be transported, for example. However, the delivery device may also be in the form of a type of outlet unit, for example an outlet connection piece or an outlet valve, to which a further line unit for forwarding the thermal energy to the consumer can then be connected. In particular, the delivery device may be arranged inside the second energy generation unit or on the latter, for example also outside the latter. The delivery device may also be arranged separately and, in particular, spatially separate from the second generation unit. Alternatively, the delivery device may be integrated with the second energy generation unit.

A delivery regulation device is also provided and can be used to establish an enabled state and a blocked state of the delivery device with regard to the delivery of thermal energy to a consumer.

In the enabled state, the delivery device and therefore the delivery of thermal energy to one or else more consumers become free, that is to say it is actually possible to deliver thermal energy generated by the apparatus for generating energy to consumers only in this state. In contrast, in the blocked state, the delivery of thermal energy to a consumer is blocked, that is to say prevented, or is restricted at least to the extent that (in particular economically and/or technically useful) use of this energy by the consumer is no longer possible. The delivery regulation device can therefore change back and forth between two states, an enabled state and a blocked state. The enabled state is in turn assigned to a first operating state of the delivery regulation device and the blocked state is assigned to a second operating state of the delivery regulation device, with the result that thermal energy can be delivered to consumers only in the first operating state and, in contrast, this is prevented in the second operating state.

As an alternative or in addition to the delivery regulation device, the apparatus comprises a control device for controlling the second energy generation unit. The control device switches on the energy generation unit only in the first operating state, with the result that this energy generation unit runs and can produce thermal energy only in this operating state. In the second operating state, the second energy generation unit remains blocked or switched off. Accordingly, thermal energy can also be delivered to a consumer only in the first operating state. In the switched-on state (first operating state of the control device), the second energy generation unit produces thermal energy, with the result that this thermal energy could in principle be delivered to one or else more consumers, that is to say it is actually possible to deliver thermal energy generated by the apparatus for generating energy to consumers only in this state. If a delivery regulation device and a delivery device are provided in addition to the control device, the thermal energy produced in the first operating state of the control device can be blocked or enabled for delivery to a consumer by the delivery regulation device. In contrast, in the switched-off state (second operating state of the control device), no thermal energy is produced. The control device can therefore change back and forth between two states, a switched-on state (activation state) and a switched-off state (deactivation state). The switched-on state is in turn assigned to a first operating state of the control device and the switched-off state is assigned to a second operating state of the control device. The control device directly controls the second energy generation unit. In addition, it is also possible for the control device to control the delivery regulation device.

In principle, it is possible for only a delivery regulation device, only a control device or both devices mentioned to be present. If only a control device is present, it may be expedient to also provide a delivery device. Furthermore, it is possible to provide a single device which comprises both the control device and the delivery regulation device.

The first operating state and also the second operating state are therefore each operating states of the delivery regulation device, according to which said device carries out either enabling or blocking. The respective operating state is expediently set, to be precise advantageously on the basis of particular factors of the apparatus, the purpose of the apparatus or else environmental factors of the apparatus. This makes it possible to achieve better adjustment or adaptation of the apparatus to the respective purpose with regard to the delivery or non-delivery of thermal energy. This advantageously makes it possible to prevent unauthorized extraction and to flexibly react to demand and cost factors in order to thus increase the efficiency. The invention now provides control with regard to whether or not thermal energy is delivered for a given operating state which is set on the basis of use factors.

Particular use factors or conditions are expediently assigned to the first operating state and other particular use factors or conditions are assigned to the second operating state. If the use factors or conditions accordingly change, the operating state may likewise change from the first operating state to the second operating state or else from the second operating state to the first operating state on the basis thereof. According to the invention, at least two operating states, namely the first operating state and the second operating state, are set. In principle, yet further operating states may also be set.

Furthermore, it is possible, in principle, for only a particular type of thermal energy to be selectively blocked for delivery to consumers in the second operating state. For example, an apparatus which can generate both heat and cold using its second energy generation unit may be designed in such a manner that, although the delivery of heat to consumers is blocked in the second operating state, the delivery of cold is not.

In the present case, the term “delivery” is understood as meaning the fact that the energy, for example thermal energy or else electrical energy, is deliberately and purposefully passed to a different consumer independent of the apparatus for generating energy. This different consumer is arranged, in particular, outside the apparatus according to the invention and spatially at a distance from the latter. In the present case, the term “delivery” should not be understood as meaning, in particular, the fact that the energy is consumed by the apparatus according to the invention itself or is used or delivered otherwise, in particular is diverted to the surrounding area. For the present application, the term “consumers” is accordingly understood as meaning only those consumers that use the electrical and/or thermal energy for specific purposes (for example so-called “loads”) or forward the energy to loads such as power supply systems or district heating networks. The ambient air or the surrounding sea is not a consumer in the sense of the present application, in particular.

The delivery regulation device may be arranged in, on or at a distance from the delivery device. The delivery regulation device may also be integrated in the delivery device.

If more operating states than only the first operating state and the second operating state can be set in particular, one preferred embodiment of the invention provides for the delivery regulation device to be designed to block the delivery device in every operating state, apart from the first operating state. This makes it possible to increase the certainty that enabling of the delivery device is actually ensured only in a single intended case or operating state.

Another preferred embodiment provides for the first energy generation unit and the second energy generation unit to be coupled to one another for the purpose of transmitting energy between the two energy generation units. In particular, the coupling may be expediently designed in the form of power-heat coupling or heat-power coupling. This makes it possible to improve the efficiency of the apparatus by virtue of energy which is not used in one energy generation unit being transferred to the second energy generation unit and being used there. This also makes it possible to integrate the two energy generation units, which improves the compactness of the entire apparatus.

The first and second energy generation units may each comprise only one or else more components. In one preferred embodiment, the first energy generation unit and the second energy generation unit each have one or more components from the following group: an internal combustion engine, a generator, a fuel cell, a device for using solar energy (such as a solar cell or a photovoltaic cell), a tidal power plant, a wave power plant, a hydroelectric power plant, a wind power plant, a biomass power plant, a device for using gaseous expansion pressures, a device for using stored energy, a device for thermally using the ground, power-heat coupling devices, preferably heat exchangers, particularly preferably exhaust gas heat exchangers, power-heat-cold coupling devices, in particular an absorption chiller, means for storing electrical energy, means for storing thermal energy. As a result of the multiplicity of different possible components in this embodiment, it becomes clear that the apparatus according to the invention can be flexibly adapted depending on the desired intended application and individual conditions of use. In this case, a plurality of the above-mentioned components can also be combined or coupled to one another or otherwise operatively connected inside an energy generation unit. The means for storing electrical energy and the means for storing thermal energy may also comprise those apparatuses which carry out or cause energy conversion for the purpose of storing energy.

In particular, it is preferred for the first energy generation unit to comprise an internal combustion engine, for example a diesel engine or a gas engine or a gas turbine, and, at the same time, to have a generator which is coupled to the internal combustion engine and is driven by the latter for the purpose of generating power. In this embodiment, the second energy generation unit also comprises a power-heat coupling device and/or a power-heat-cold coupling device for generating thermal energy using the waste heat, in particular the waste heat of the exhaust gases, of the internal combustion engine of the first energy generation unit. This power-heat coupling improves the efficiency insofar as the second energy generation unit itself generates energy, for example in the form of heated fluid, preferably heated heating water, using energy obtained from the first energy generation unit in order to then deliver this energy to consumers in the suitable operating state, in particular in the first operating state. The apparatus may comprise further components or may finally consist of the components of an internal combustion engine, a generator and a power-heat coupling device and/or power-heat-cold coupling devices.

The apparatus according to the invention particularly preferably comprises a combined heat and power plant. In this case, both the first energy generation unit and the second energy generation unit are each different components of the combined heat and power plant. In particular, combined heat and power plants often comprise internal combustion engines for producing power using a generator driven thereby and a device for using the waste heat of the internal combustion engine to produce thermal energy. The delivery device and also the delivery regulation device are advantageously likewise integrated in the combined heat and power plant. In this exemplary embodiment, the apparatus may be produced as a particularly compact unit and can be easily moved or transported from one place to another if necessary.

In another preferred embodiment, the delivery regulation device has regulation means. These regulation means may be, in particular, blocking means which are operated mechanically, electrically, electromechanically, pneumatically and/or hydraulically, for example. The delivery device can be enabled or blocked by activating or deactivating the blocking means. The regulation means particularly preferably comprise one or more components from the following group of components: valves, a bypass line, shut-off means, in particular shut-off valves, a shut-off flap or a ball valve. This makes it possible to effectively adjust or change between enabling and blocking or between the first operating state and the second operating state in a simple manner. A drive for switching or setting the regulation means is expediently provided either separately or in a manner integrated with the regulation means. Depending on the type of blocking means, the drive can have a mechanical, electrical, electromechanical, pneumatic, hydraulic or another suitable design.

In another preferred embodiment of the apparatus, coding means for inputting a code are provided. In this case, a predetermined first code is expediently assigned to the first operating state and a predetermined second code is assigned to the second operating state. If the apparatus is in the second operating state, for example, and if the first code is input to the coding means, for example by an operator, the apparatus or the delivery regulation device establishes the first operating state by setting the regulation means and enables the delivery device for the purpose of delivering thermal energy to consumers. Conversely, the delivery device can be blocked by inputting a second code, as a result of which the second operating state is established. This embodiment makes it possible to achieve the situation in which the delivery of thermal energy can be enabled only by personnel specifically authorized for this purpose, for example. This makes it possible to prevent unauthorized energy extraction. As a result, this also makes it possible to provide for enabling to be carried out only under certain circumstances, in which case the corresponding first code is then input only when these predetermined circumstances are present. The first code or else the second code can be directly input by an operator using an input apparatus or the like provided for this purpose. The input apparatus may be part of the coding means or may be operatively connected to the latter. Alternatively, the code may also be remotely transmitted to a spatially remote location, in which case corresponding remote transmission means, for example a wired connection or a wireless radio connection, then need to be provided. In this respect, the codes may exist in a predetermined signal or a predetermined signal sequence. In principle, all suitable signals or codes or all signals or codes known from the prior art can be used. If the codes are directly input by operating personnel, the use of a number or letter code is appropriate, for example, in which case a corresponding input keyboard then needs to be provided.

Furthermore, a time measurement unit may be additionally provided. A certain time within which the first code must be input is then set, otherwise the second operating state is automatically established, that is to say the delivery regulation device blocks the delivery device. In such an embodiment, it may be expedient to provide only a single predetermined first code and no further codes. In this exemplary embodiment, input of the first code causes the delivery regulation device to enable the delivery device. At the same time, the time measurement unit is used to continuously compare the period since the last input of the first code with the maximum predefined period. As soon as the measured period exceeds the predefined maximum period, a change is made back to the second operating state and the delivery regulation device blocks the delivery device again.

In another preferred embodiment, a control device is also provided and controls the regulation means of the delivery regulation device in such a manner that the regulation means enable the delivery device for the purpose of delivering the thermal energy in the first operating state and block the delivery device in the second operating state. In particular, the control device can receive inputs or signals/input signals from other devices, on the basis of which the control device then in turn controls the regulation means. The control device and the delivery regulation device may be in the form of an integrative component or else separate components.

Furthermore, the control device for controlling the regulation means may be provided in addition to the control device for controlling the second energy generation unit. Alternatively, it is also possible to provide only a single control device which is designed in such a manner that it performs or can undertake both functions.

If coding means are additionally provided, it is expedient that the coding means generate an enable signal and transmit the latter to the control device when the predetermined first code is input. After receiving the enable signal, the control device accordingly controls the delivery regulation device such that the latter enables the delivery device. In a similar manner, the coding means preferably generate a blocking signal when the predetermined second code is input, which blocking signal is likewise transmitted to the control device, whereupon the latter controls the delivery regulation device for the purpose of blocking the delivery device. In particular, provision may be made for the control device to control the regulation means of the delivery regulation device only after receiving the enable signal for enabling the delivery device. This also ensures that the delivery device is enabled for the purpose of delivering thermal energy only when the correct code is input. The enable signal can preferably be queried at predefined intervals of time, the enabling of the delivery device being blocked as soon as an enable signal is no longer present. Alternatively or additionally, the blocking can be carried out after a maximum period has expired if an enable signal has not been transmitted a second time within the maximum period.

It is also expedient to provide an input apparatus which can be used by an operator to transmit commands to the control device. The input device may be in wired or wireless data communication with the control device and may accordingly be part of the control device or else may be arranged at a spatial distance from the control device or even the apparatus. As a result, operators may react to respectively changing conditions of use or environmental conditions by inputting corresponding commands and the control device can accordingly control the delivery regulation device or its regulation means for the purpose of establishing the respectively required operating state. However, it may be expedient for the direct input of commands to be permissible only to a limited extent for operating personnel and for the first operating state to be able to be established only when the enable signal is present, for example, without the possibility of an “override” by the operating personnel.

In another preferred embodiment, the apparatus may comprise a sensor device for determining parameters of the apparatus or parameters of components of the apparatus or other measurement data or measured values. It is possible to predefine which parameters or measurement data can be determined and/or the sensor device may be designed to record only one type of parameter or measured value or a plurality of parameters or measured values.

Examples of such parameters of the apparatus or components of the apparatus are, for example, the geographical position of the apparatus or its components, performance data relating to the apparatus such as the amount of electrical and/or thermal energy produced, the efficiency, the operating temperature, other operating parameters of the first or second energy generation unit, state of fuel supplies, etc. Examples of measurement data are the time, the date, the tidal state, the swell, the direction of water flow, the speed of water flow, the air temperature, the water temperature, the wind direction, the wind speed, the humidity, the composition of the ambient air, the type or number of particles in the ambient air, the distance between the apparatus and defined reference points, etc. The sensor device is designed to transmit the determined parameters or measurement data or measured values to the control device, the control device being designed to determine and/or set the operating state on the basis of the transmitted parameters or measurement data. In other words, the control device decides on the basis of the transmitted measurement data or parameters which operating state is to be assumed and accordingly controls the delivery regulation device. For this purpose, the control device has a suitable algorithm which can be used to calculate the respectively appropriate operating state using the measured data. Alternatively or additionally, comparison or reference data may be stored in the control device, the latter then comparing the reference data with the measured data and deciding on the operating state on the basis of this comparison and accordingly controlling the delivery monitoring apparatus.

In principle, according to another embodiment, it may be possible for the control device to additionally control the first and/or second energy generation unit and to activate or deactivate said units independently of one another on the basis of the measured parameters or measurement data.

According to another embodiment, provision may be made of a regulation signal receiving device which can receive a superordinate regulation signal. The regulation signal receiving device is expediently likewise connected to the control device. The regulation signal is a high-ranking signal insofar as the first operating state or else the second operating state can be assumed, irrespective of further specifications, signals, measurement data or other measured parameters received by the control device, only when the regulation signal is present or absent. On the basis of the data received from the sensor device for example, the control device would calculate that the first operating state, that is to say the enabling of the delivery device, should be established. In a further step, the control device would monitor whether the superordinate regulation signal is present at the same time. If this signal were not present, the control device would not enable the delivery regulation device, although the establishment of the first operating state and therefore the enabling of the delivery device should be executed on the basis of the determined values. This accordingly provides a dual security and monitoring system, thus further reducing the risk of the delivery device being enabled in an undesirable manner. In this embodiment, the control device therefore controls the regulation means on the basis of the presence or absence of a regulation signal, but it may be the case in some circumstances that yet further conditions, for example the calculation of a suitable value on the basis of the data received from the sensor device, must be additionally present so that particular control of the regulation means is carried out. The presence or absence of the regulation signal alone may also be sufficient depending on the setting or selected construction. However, the regulation signal should always be understood such that it has a superordinate meaning, that is to say it must be present in any case in order to enable the delivery device and therefore establish the first operating state.

The regulation signal receiving device preferably receives the regulation signal if one or more conditions of the following group are satisfied: manual enabling carried out by authorized operating personnel situated at the apparatus or spatially remote from the apparatus, emission of the regulation signal by a control centre spatially remote from the apparatus, establishment of a connection between the delivery device and a consumer, in particular a preferably predetermined shore-based consumer, identification of a consumer coupled to the delivery device as the predetermined consumer, exceeding or undershooting of a predefined spatial distance between the apparatus and a predetermined reference point, and residence or non-residence of the apparatus in a predetermined spatial region. The manual enabling can also be carried out, for example, by inputting a suitable code or the first code to the coding means. Selecting the suitable conditions makes it possible to respectively optimally adapt the apparatus to the respective intended applications or application conditions.

It may also be preferred for the second operating state to be automatically assumed as soon as the regulation signal receiving device does not receive a regulation signal within a respective predetermined period of time. In this case, the control device accordingly controls the regulation means as soon as it has not received a regulation signal from the regulation signal receiving device within the predetermined period of time. This embodiment further increases the reliability of the apparatus.

In another preferred embodiment, the apparatus has a forwarding device for forwarding the electrical energy generated by the first energy generation unit to a consumer and a forwarding regulation device, the forwarding regulation device being designed to enable the forwarding device of the first energy generation unit in a third operating state and to block the forwarding device in a fourth operating state. In this case, the forwarding device may be in the form of a suitable conductor for electrical energy or for power. The forwarding regulation device may also preferably be designed in a similar manner to the delivery regulation device including its relationship with respect to or dependence on the control device, the regulation signal receiving device and other components. Furthermore, the third or fourth operating state can be respectively assigned to the first and second operating states or the third operating state can correspond to the first or second operating state and the fourth operating state can correspond to the first or second operating state, in which case it goes without saying that the third and fourth operating states each expediently do not correspond to the same operating state at the same time.

According to another preferred embodiment, a display device is provided for the purpose of displaying the operating state and possibly for the purpose of displaying performance data relating to the apparatus. This display device makes it easier for operating personnel, in particular, to discern the operating state at a given time.

In another aspect, the invention relates to a buoyant energy supply apparatus, this apparatus comprising a buoyant supporting body, in particular a watercraft, preferably a barge. The buoyant energy supply apparatus also has an above-described apparatus for generating energy, the apparatus being arranged on the buoyant supporting body. In this case, the thermal energy generated by the second energy generation unit is advantageously delivered to a consumer arranged outside the buoyant supporting body, in particular to a shore-based consumer. The consumer is therefore preferably outside the buoyant supporting body. In particular, such a consumer is a shore-based energy supply network. In a similar manner, it is also preferred for the electrical energy to also be delivered to a consumer arranged outside the buoyant supporting body, in particular a shore-based consumer, and particularly preferably a shore-based energy supply network. However, it is likewise preferred for the electrical power to also be delivered to a further watercraft. This may be advantageous, in particular, if the buoyant energy supply apparatus is used in the harbour as a buoyant harbour power supply and is intended to supply power to further watercraft anchored in the harbour, for example cruise ships. It may be only additionally advantageous, in particular with regard to the electrical energy, if the buoyant supporting body itself or its drive can also be supplied with electrical energy as a further consumer. As a result, the buoyant supporting body can move back and forth in the harbour, for example, using the self-generated electrical energy until the desired destination, for example a further ship, has been reached. The buoyant energy supply apparatus is then coupled to the ship and supplies the latter with electrical energy.

In one embodiment of the buoyant energy supply apparatus, the first energy generation unit has a forwarding device for forwarding the generated electrical energy to a consumer, the forwarding device for feeding power from the apparatus into a consumer on the watercraft and/or into a shore-based consumer being designed both for connection to a consumer on watercraft, preferably an on-board power supply system, and for connection to a shore-based consumer, preferably a shore-based power supply system. Furthermore, the delivery device for delivering the thermal energy from the second energy generation unit is designed for connection to a shore-based consumer, preferably a district heating network, for the purpose of feeding heated fluid from the apparatus into the shore-based consumer. In particular, it is preferred for the delivery device to be designed only for connection to shore-based consumers, particularly preferably a single predetermined shore-based consumer. This embodiment means that the delivery device and also the forwarding device are designed from the outset in such a manner that they can be coupled only to those devices which are predetermined to accept the energy. In the case of electrical energy, these may be both ships or on-board power supply systems of ships and shore-based consumers such as energy supply networks or power supply networks. In the case of thermal energy, the preferred consumer is a shore-based energy supply apparatus. It is expedient, for economical reasons, to deliver only the thermal energy to shore-based consumers. In this case, the delivery devices, for example, may have such a configuration that the latter is compatible only with a particular mating part of a predetermined shore-based consumer for the purpose of coupling. The connection of other consumers is therefore excluded. Alternatively or additionally, limitation of the consumers for the delivery device or the second energy generation unit may be ensured by the acceptance regulation device. The forwarding device may also be configured in such a manner that it can be coupled only to the predetermined consumers, both on water and on land.

In another aspect, the invention relates to a system comprising a buoyant energy supply apparatus as described above. The system additionally comprises a shore-based consumer for electrical energy, preferably a shore-based power supply system, and a watercraft comprising a consumer for electrical energy on the watercraft, in particular an on-board power supply system. Furthermore, the buoyant energy supply apparatus feeds electrical energy generated by the first energy generation unit into a shore-based consumer for electrical energy in the first operating state. In contrast, the buoyant energy supply apparatus feeds electrical energy generated by the first energy generation unit into a consumer for electrical energy on a watercraft in the second operating state. In this case, the term “in the operating state” relates to the operating state of the delivery regulation device and/or the operating state of the control device for controlling the second energy generation unit.

The system preferably also has a shore-based consumer for thermal energy, in particular a shore-based district heating network, the buoyant energy supply apparatus feeding thermal energy generated by the second energy generation unit into a shore-based consumer for thermal energy in the first operating state. In contrast, the system does not have a consumer for thermal energy on the watercraft.

In another aspect, the invention relates to a system comprising a buoyant energy supply apparatus described above and a predetermined consumer arranged outside the buoyant energy supply apparatus for the thermal energy generated by the second energy generation unit, the apparatus for generating energy of the buoyant energy supply apparatus comprising a forwarding device for forwarding the thermal energy generated by the second energy generation unit to the consumer, the consumer comprising a means of identification, the buoyant energy supply apparatus being set up to detect the means of identification, in which case, only if the means of identification is detected by the buoyant energy supply apparatus,

the delivery regulation device is designed to enable the delivery device, and/or

the control device for controlling the second energy generation unit is designed to activate the second energy generation unit, and/or

an acceptance blocking apparatus of the consumer is designed to accept the thermal energy forwarded to the consumer by the forwarding apparatus of the buoyant supply device, and/or

a forwarding regulation device of the forwarding device is designed to enable the forwarding device.

It is advantageous in this case that it is ensured that the thermal energy generated by the second energy generation unit is delivered only to approved predetermined consumers and is not fed into additional consumers in an unauthorized manner. The means of identification can have various designs. It may be an electronic means of identification, for example a readable code or the like, or else a mechanical means of identification, for example a key, a latch mechanism or the like, or a combination of the two. The buoyant energy supply apparatus is designed in such a manner that it detects the means of identification. In this case, provision may be made, for example, for the detection to be effected when the buoyant energy supply device is within a certain spatial distance from the predetermined consumer or the means of identification. Provision may also be made for the means of identification to be detected at the moment at which the predetermined consumer is connected to the forwarding device. The system is also designed in such a manner that it is ensured that the thermal energy is delivered to the predetermined consumer by the buoyant energy supply apparatus only if the means of identification is detected by the buoyant energy supply apparatus. For this purpose, if the means of identification is detected, either the delivery regulation device may be set up to enable the delivery device, the control device for controlling the second energy generation unit may be designed to activate the second energy generation unit, an acceptance blocking apparatus provided at the predetermined consumer may be designed to accept the thermal energy forwarded to the consumer by the forwarding apparatus in the buoyant supply device, or a forwarding regulation device of the forwarding device may be designed to enable the forwarding device. If the means of identification is not detected, the above-mentioned devices (delivery regulation device, control device, acceptance blocking apparatus and/or forwarding regulation device) are each not enabled or are blocked or deactivated or themselves carry out blocking. The above-mentioned measures can each be provided individually or else in a suitable combination with one another.

The predetermined consumer preferably also comprises a coupling device for connecting the forwarding device to the consumer. In this case, it is also preferred for the acceptance apparatus to be arranged on the coupling device. The means of identification may also be provided on the coupling device.

Another preferred embodiment of the system provides for the acceptance blocking apparatus and/or the forwarding regulation device to each comprise a detachably arranged identifier means, the identifier means each being enabled for removal only when the acceptance blocking apparatus and the forwarding regulation device are in the enabling state, and for the delivery regulation device to enable the delivery device only when the identifier means are enabled and/or are supplied to the delivery regulation device, the means of identification comprising the identifier means of the acceptance blocking apparatus, in particular. The identifier means may be, for example, keys, chip cards or latches which are arranged on the acceptance blocking apparatus and/or on the forwarding regulation device. The identifier means are arranged there in such a manner that they are permanently installed and cannot be removed or detached as long as the acceptance blocking apparatus and/or the forwarding regulation device is/are in the blocked state. The identifier means can be removed only when the acceptance blocking apparatus and the forwarding regulation device are enabled. The delivery regulation device provided on the buoyant energy supply apparatus in turn enables the delivery of the thermal energy only when the previously removed identifier means have been supplied to the delivery regulation device. If the identifier means are in the form of keys, for example, they must be removed from the acceptance blocking apparatus and/or the forwarding regulation device after it/they has/have been enabled and must be inserted into the delivery regulation device. Only then can the thermal energy be delivered to the predetermined consumer. Such a system provides double security against unauthorized delivery of thermal energy to a predetermined consumer.

Another preferred embodiment of the system provides for the system to comprise an identifier means storage device which contains a further identifier means for being supplied to and for enabling the delivery regulation device, the identifier means storage device being designed to receive the identifier means of the acceptance blocking apparatus and/or the forwarding device and to enable the further identifier means when the identifier means of the acceptance blocking apparatus and/or the forwarding device is received. This means that the identifier means of the acceptance blocking apparatus and/or the forwarding regulation device do not have to be directly supplied to the delivery regulation device but rather can be arranged in an identifier means storage device, the further identifier means then in turn being able to be removed from this identifier means storage device as soon as the other two identifier means have been introduced. This may be useful if, on account of the given circumstances, it is difficult for users to insert the identifier means of the acceptance blocking apparatus and/or the forwarding regulation device into the delivery regulation device or if these identifier means are not compatible with the delivery regulation device.

In another aspect, the invention relates to a method for supplying a predetermined consumer with thermal energy using a system comprising a buoyant energy supply apparatus described above and a predetermined consumer arranged outside the buoyant energy supply apparatus for the thermal energy generated by the second energy generation unit, characterized by the following steps

the delivery of thermal energy generated by the second energy generation device to consumers is blocked;

a means of identification of the predetermined consumer is detected by the buoyant energy supply apparatus;

a forwarding device for forwarding the thermal energy generated by the second energy generation unit to the predetermined consumer is connected;

the delivery of thermal energy generated by the second energy generation device to the predetermined consumer is enabled; and

the thermal energy generated by the second energy generation device is delivered to the predetermined consumer by the buoyant energy supply apparatus.

In this method, the delivery of thermal energy generated by the second energy generation device to (any) consumers is generally blocked. The thermal energy can be delivered to a predetermined consumer only if the buoyant energy supply apparatus recognizes the predetermined consumer using a means of identification of the predetermined consumer. This ensures that it becomes impossible to deliver thermal energy to consumers other than the predetermined consumers.

In one preferred embodiment of the method, the buoyant energy supply apparatus checks whether the means of identification of the predetermined consumer is still present, the delivery of thermal energy generated by the second energy generation device to consumers being blocked as soon as the check reveals that the means of identification is no longer present. In this case, the check can be carried out once or continuously. It is also possible to carry out the check using a preceding schedule. Furthermore, the check can be initiated and/or carried out automatically or manually. In the present embodiment, provision may also be made for the means of identification to have to be provided within a certain predefined spatial distance from the buoyant energy supply apparatus. If the means of identification is outside this spatial distance, it is no longer detected by the buoyant energy supply apparatus and the delivery of thermal energy generated by the second energy generation device to consumers is blocked.

In another preferred embodiment of the method, the means of identification comprises a detachably arranged identifier means, a further, detachably arranged identifier means preferably being provided in the region in which the forwarding apparatus is connected to the buoyant energy supply apparatus, the identifier means being designed in such a manner that they can be removed only after the forwarding device has been connected to the predetermined consumer and/or to the buoyant supply device, the following steps being carried out:

the identifier means are removed after the forwarding device has been connected to the predetermined consumer and/or to the buoyant energy supply apparatus, and

the identifier means are supplied to the delivery regulation device, or

the identifier means are supplied to an identifier means storage device, a further identifier means arranged in the identifier means storage device being enabled as a result of the identifier means being supplied, the further identifier means then being supplied to the delivery regulation device.

This embodiment of the method further increases the security against unauthorized delivery of thermal energy to consumers which are not predetermined insofar as additional identifier means are provided and can be removed or detached from their arrangements only after the forwarding device has been connected to the predetermined consumer and/or to the buoyant supply device. The further identifier means arranged in the identifier means storage device can be removed only when the detached identifier means are introduced into the identifier means storage device. Insertion of this further identifier means into the delivery regulation device can then initiate the delivery of the thermal energy. The above statements with respect to the possible configurations of the identifier means storage device or the identifier means for the system described above can also be applied to the present method.

In another aspect, the invention relates to a method for supplying consumers with electrical energy and possibly with thermal energy using an apparatus for generating energy, comprising a first energy generation unit for generating electrical energy, in particular power, and a second energy generation unit for generating thermal energy, in particular heat and/or cold, the apparatus being designed according to one of the above-described apparatuses for generating energy. In the method, an operating state of the apparatus or of a component of the apparatus is determined and/or set, electrical energy generated using the first energy generation unit being fed into a shore-based consumer for electrical energy, in particular a shore-based power supply system, and thermal energy generated using the second energy generation unit possibly being fed into a shore-based consumer for thermal energy, in particular a shore-based district heating network, when a first operating state is determined and/or set. According to the method, electrical energy generated using the first energy generation unit is fed into a consumer for electrical energy on a watercraft, in particular an on-board power supply system of a watercraft, and the delivery of thermal energy generated using the second energy generation unit to consumers is blocked at the same time. The blocking can also be effected by switching off or deactivating the second energy generation unit, when a second operating state is determined and/or set.

In one preferred embodiment of the method, the delivery of thermal energy generated using the second energy generation unit to consumers is blocked in every operating state, apart from the first operating state. It is also preferred for the delivery of thermal energy generated using the second energy generation unit to a shore-based consumer for thermal energy to be enabled in the first operating state.

In another preferred embodiment of the method, the apparatus is arranged on a buoyant supporting body thus forming a buoyant energy supply apparatus, the buoyant energy supply apparatus being moored to land or situated on land in the first operating state and the delivery of thermal energy generated using the second energy generation unit to consumers being blocked as soon as the buoyant energy supply apparatus leaves land. In this embodiment of the method, the process of leaving land signifies the second operating state, whereas the first operating state is established as long as the buoyant supporting body having the apparatus is moored to land or situated on land.

### BRIEF DESCRIPTION OF THE FIGURES

One preferred embodiment of the invention is explained in more detail below using the figures, in which schematically:

FIG. 1: shows a schematic illustration of a buoyant energy supply apparatus;

FIG. 2: shows a buoyant energy supply apparatus in a first operating state;

FIG. 3: shows a buoyant energy supply apparatus in a second operating state; and

FIG. 4: shows a flowchart.

### PREFERRED EMBODIMENT OF THE INVENTION

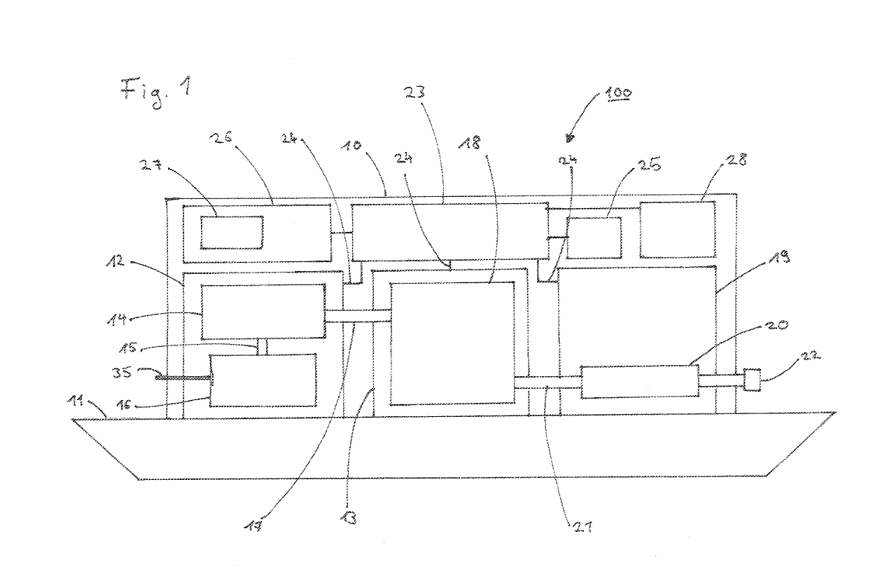

FIG. 1 shows a buoyant energy supply apparatus 100 comprising an energy supply apparatus 10 according to the invention which is arranged on a buoyant barge 11. The energy supply apparatus 10 arranged on the buoyant barge 11 comprises a first energy generation unit 12 for generating electrical energy and a second energy generation unit 13 for generating thermal energy. The first energy generation unit 12 and the second energy generation unit 13 together form a combined heat and power plant or are components of a combined heat and power plant.

The first energy generation unit 12 has an internal combustion engine 14 which is connected to a generator 16 via a drive shaft 15 for the purpose of generating electrical energy. The exhaust gases produced in the combustion process taking place inside the internal combustion engine 14 are passed to a power-heat coupling device 18 of the second energy generation unit 13 using an exhaust gas line 17. The power-heat coupling device 18 transfers the thermal energy of the waste heat delivered by the first energy generation unit 12 to a fluid, preferably water or heating water. The heated fluid or the heated heating water produced thereby can then be provided for suitable consumers by the energy supply apparatus 10.

The energy supply apparatus 10 according to the invention also comprises a delivery regulation device 19 which, in the preferred embodiment, is integrated in the energy supply apparatus 10. The delivery regulation device 19 also has a regulation means 20, in particular a valve, which is suitable for regulating or controlling a fluid flow, in particular a flow of a heated fluid or heated heating water. The heated heating water generated using the second energy generation unit 13 is introduced into the delivery regulation device 19 by means of a heating water line 21 and is regulated or controlled using the regulation means 20. The heating water line 21 and a coupling device, which is arranged at the end of the latter and is intended to connect further lines, together form a delivery device.

The delivery regulation device 19 comprising the regulation means 20 can change back and forth between two states, an enabled state and a blocked state, for the purpose of controlling or regulating the heating water flow. In the enabled state, the delivery regulation device 19 allows thermal energy to be delivered to a suitable consumer by appropriately adjusting the regulation means 20. Conversely, in the blocked state of the delivery regulation device 19, thermal energy is prevented from being delivered to an unsuitable consumer. In particular, the regulation means 20 of the delivery regulation device 19 may have a valve which is open in the enabled state and is closed in the blocked state, with the result that thermal energy in the form of heated heating water can be delivered to a suitable consumer in the enabled state and the delivery of thermal energy in the form of heated heating water is prevented in the blocked state.

In this case, a first operating state is assigned to the enabled state of the delivery regulation device 19 and a second operating state is assigned to the blocked state of the delivery regulation device 19. If the first operating state is present and if the delivery regulation device 19 is therefore in the enabled state, the delivery of thermal energy in the form of heated heating water to a consumer is allowed using the regulation means 20 and the heated heating water can pass through the delivery regulation device 19 and can be delivered to a suitable consumer for further use via a coupling device 22 which is in the form of an outlet connection piece in the preferred embodiment.

In order to establish the first operating state and/or the second operating state of the delivery regulation device 19, the energy supply apparatus 10 integratively comprises a control device 23 which is connected, via control lines 24, to the delivery regulation device 19 and to the first energy generation unit 12 and the second energy generation unit 13. The control device 23 controls the regulation means 20 of the delivery regulation device 19 in such a manner that the regulation means 20 enable the delivery of the thermal energy in the first operating state via the coupling device 22 and block the delivery of the thermal energy in the second operating state. For this purpose, the control device 23 may receive inputs or signals/input signals from other devices. The control device 23 determines the operating state of the delivery regulation device 19 or sets the operating state of the delivery regulation device 19 on the basis of the signals/input signals, that is to say the control device 23 establishes the first operating state or the second operating state of the delivery regulation device 19 on the basis of the signals or input signals, with the result that the delivery regulation device 19 accordingly assumes the enabled state or the blocked state.

The inputs or signals/input signals are delivered to the control device 23 from further devices. The control device 23 receives measurement data or measured values or measured values of parameters determined by a sensor device 25. The sensor device 25 is designed to transmit the determined parameters or measurement data or measured values to the control device 23, the control device 23 being designed to determine and/or set the operating state of the delivery regulation device 19 on the basis of the transmitted parameters or measurement data. The parameters determined by the sensor device 25 may be, for example, the time, the wind speed, the composition of the ambient air, the type or number of particles in the ambient air or the distance between the energy supply apparatus 10 and predefined reference points. However, many other parameters which can be determined by the sensor device 25 are also conceivable.

In addition to the signals from the sensor device 25, the control device 23 is designed to receive signals from a coding means 26. The coding means 26 can be used to transmit an enable signal or a blocking signal to the control device 23, the enable signal or blocking signal transmitted to the control device 23 being used, in addition to the measurement data or measured values from the sensor device 25 of the control device 23, as the basis for determining or establishing the first or second operating state of the delivery regulation device 19.

The enable signal and the blocking signal may be in the form of a predetermined code. In this case, the code can be input to an input apparatus 27 of the coding means 26 by operators or operating personnel, in particular. As a result, operators can react to respectively changing conditions of use or environmental conditions by inputting corresponding commands, and the control device 23 can accordingly control the delivery regulation device 19 or its regulation means 20 in order to establish the respectively required operating state.

A further input signal for the control device 23, a regulation signal, is transmitted to the control device 23 by a regulation signal receiving device 28. The regulation signal from the regulation signal receiving device is a high-ranking signal insofar as, irrespective of further specifications, signals, measurement data or other measured parameters or operating personnel inputs received by the control device, the first or else the second operating state can be assumed only when the regulation signal is present or absent.

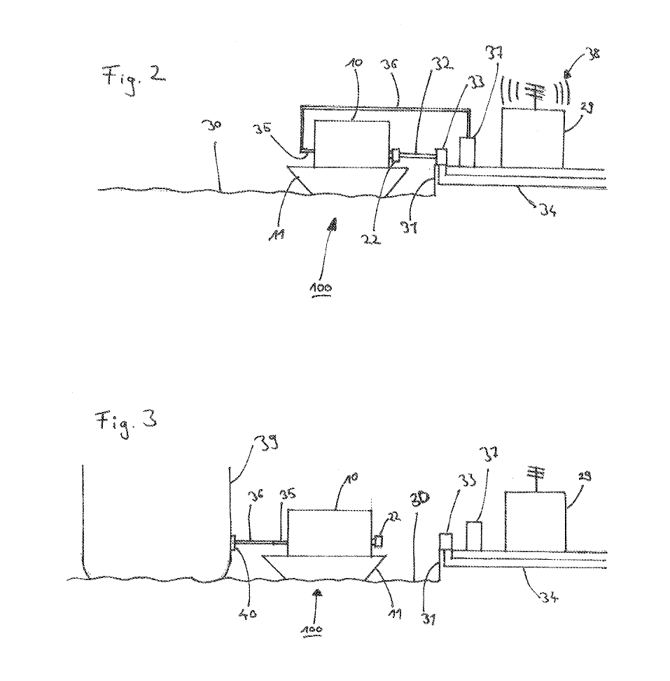

The high-ranking or superordinate regulation signal which is passed to the control device 23 by the regulation signal receiving device 28 can be received by the regulation signal receiving device 28 from a control centre, as is denoted using reference symbol 29 in FIG. 2 for example, which is spatially remote from the energy supply apparatus 10. As a result of the fact that the regulation signal is received by the regulation signal receiving device 28, it is therefore possible to ensure that the control device 23 can establish the first operating state of the delivery regulation device 19 only when the regulation signal is received and that the delivery regulation device 19 assumes the enabled state and therefore allows thermal energy in the form of heated heating water to be delivered through the coupling device 22 via the regulation means 20 only when the regulation signal is present.

In this case, the regulation signal from the control centre 29 (FIGS. 2 and 3) is transmitted only when the energy supply apparatus 10 is or has been connected to a predetermined shore-based consumer for the purpose of transmitting thermal energy. If the energy supply apparatus 10 is not connected to a predetermined shore-based consumer or the energy supply apparatus 10 is connected to another consumer, for example a consumer on a watercraft, the regulation signal is not transmitted.

Emitting the regulation signal therefore makes it possible to ensure that thermal energy in the form of heated heating water is delivered only to a shore-based consumer predetermined for this purpose. In order to ensure efficient and cost-saving use of the energy supply apparatus 10, the control device 23 can control the first energy generation unit 12 and/or the second energy generation unit 13 on the basis of the input signals from coding means 26, the sensor device 25 and the regulation signal receiving device 28, which are supplied to the control device 23, in such a manner that the first and/or second energy generation unit is/are possibly switched on or off.

FIGS. 2 and 3 are used below to explain how the delivery of thermal energy in the form of heating water to a suitable shore-based consumer is controlled by means of the regulation signal and how the delivery of electrical energy generated by the first energy generation unit 12 to a consumer on a watercraft predetermined for this purpose and/or to a shore-based consumer predetermined for this purpose is controlled by means of the regulation signal.

FIG. 2 shows a buoyant energy supply apparatus 100 comprising a buoyant barge 11 and an energy supply apparatus 10 according to the invention arranged on the barge 11. The buoyant energy supply apparatus 100 is situated on a body of water 30 and is present at a quay or a shore boundary 31. In particular, the barge 11 may be moored at the shore boundary 31.

The coupling device 22 for thermal energy in the form of heating water of the energy supply apparatus 10 is connected to a further coupling device 33 of a shore-based consumer via a pipeline 32, the shore-based consumer being a shore-based district heating network 34. Furthermore, the first energy generation unit 12 for generating electrical energy in the energy supply apparatus 10 is connected to a feed apparatus 37 for feeding power into a shore-based power supply system via a forwarding device 35 (also see FIG. 1) and a power line 36 which is connected to the forwarding device 35.

The control centre 29 arranged on land and at a spatial distance from the apparatus transmits the regulation signal in the form of a radio signal 38. Upon receiving the regulation signal by means of the regulation signal receiving device 28 and upon receiving the enable signal from the coding means 26, which was generated by operating personnel using the input apparatus 27, and possibly taking into account measured parameters or measured values from the sensor device 25, the control device 23 determines that it is possible to establish a connection for transmitting thermal energy in the form of heating water to predetermined shore-based consumers and consequently establishes the first operating state of the delivery regulation device 19 which therefore changes to the enabled state. Accordingly, thermal energy in the form of heating water can be transmitted to a shore-based consumer predetermined for this purpose, here a district heating network 34, in the enabled state.

The control device 23 also controls the first energy generation unit 12 for generating electrical energy in such a manner that electrical power is delivered to the feed apparatus 37 of the shore-based power supply system via the forwarding device 35 and the power line 36. The control centre 29 determines whether the regulation signal is intended to be transmitted. In this case, the control centre 29 can use, for example, the location data relating to the buoyant energy supply apparatus 100, as determined by a locating system, for the decision regarding whether a regulation signal is intended to be transmitted.

In order to determine the location data, a GPS system, for example, may be arranged for this purpose on the buoyant energy supply apparatus 100 which transmits the location data to the control centre 29, in particular by radio. The control centre 29 can then use the location data, or else further data determined either by the buoyant energy supply apparatus 100 or by further sensor systems, to stipulate whether a superordinate regulation signal is intended to be transmitted to the control device 23. If the appropriate conditions are present, which may also comprise, in particular, the undershooting of a predefined spatial distance from the coupling device 33 of the predetermined shore-based consumer and the establishment of the connection to the coupling device 33 of the predetermined shore-based consumer, the control centre 29 transmits the regulation signal in the form of a radio signal 38.

The regulation signal is received by the regulation signal receiving unit 28 of the energy supply apparatus 10 and is forwarded to the control device 23 which establishes the first operating state and therefore the enabled state of the delivery regulation device 19, possibly on the basis of further input signals from the sensor device 25, as soon as the enable signal from the coding means 26 is received, the enable signal being transmitted in the form of a code generated by operating personnel using an input apparatus 27. The combination of the regulation signal and the enable signal generated by the operating personnel using the input apparatus 27 of the coding means 26 therefore ensures that thermal energy in the form of heated heating water is delivered to the shore-based consumer, here a shore-based district heating network 34, only when the energy supply apparatus 10 is connected to a shore-based consumer predetermined for this purpose via the coupling device 22 and the pipeline 32.

FIG. 3 shows the buoyant energy supply apparatus 100 which is present on a consumer for electrical energy on a watercraft. The consumer of electrical energy on the watercraft is in the form of a ship 39. The first energy generation unit 12 or the generator 16 of the first energy generation unit 12 is connected to an electrical connection device 40 designed for this purpose in the ship 39 via the forwarding device 35 and via a power line 36 for the purpose of forwarding electrical energy. On the basis of the location data and, under certain circumstances, on the basis of further parameters transmitted to the control centre 29 by the sensor device 25, the control centre 29 determines that the buoyant energy supply apparatus 100 does not undershoot the predetermined distance from a predetermined shore-based consumer of thermal energy and is also not connected to such a shore-based consumer and therefore does not transmit a regulation signal. Since a regulation signal is therefore not received by the regulation signal receiving device 28 of the energy supply apparatus 100 either, the control device 23 likewise does not receive a superordinate regulation signal, with the result that the first operating state of the delivery regulation device 19, which constitutes the enabled state of the regulation means 20, is not established by the control device 23.

The input of the enable code by operating personnel using the input apparatus 27 of the coding means 26 therefore does not result in the delivery regulation device 19 assuming the first operating state or the enabled state since the control device 23 does not receive the regulation signal. In contrast, the enable signal which is generated by the operating personnel, under certain circumstances by heeding further parameters or measured values delivered by the sensor device, is used to enable the first energy generation apparatus 12 for the purpose of generating electrical energy, with the result that this energy generation apparatus delivers electrical power to the consumer on the watercraft, here the ship 39, via the forwarding device 35 and the power line 36.

The fact that a corresponding regulation signal from the control centre 29 is not received therefore means that, if the buoyant energy supply apparatus 100 is connected to a consumer on a watercraft, thermal energy in the form of heated heating water is prevented from being able to be delivered to the consumer on the watercraft.

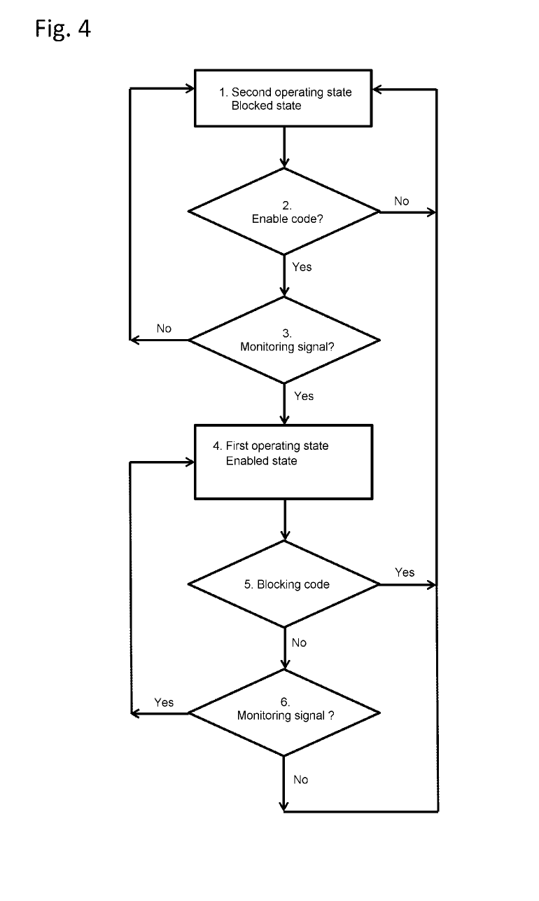

FIG. 4 shows a flowchart illustrating the decision-making process or the control process of the energy supply apparatus 10 or the buoyant energy supply apparatus 100. In particular, the flowchart shows how the process switches back and forth between a first operating state and a second operating state or between an enabled state and a blocked state of the delivery regulation device 19. In this case, it is assumed that the delivery regulation device 19 is in the second operating state, which constitutes the blocked state, at the beginning of the sequence.

The delivery regulation device 19 is in the second operating state if it is not connected to a shore-based consumer of thermal energy predetermined for this purpose. This situation occurs, for example, when the energy supply apparatus 10 is connected to a consumer of electrical energy on a watercraft or if the buoyant energy supply apparatus 100 is connected neither to a consumer of, in particular thermal, energy on a watercraft nor to a shore-based consumer of, in particular thermal, energy.

If the delivery regulation device 19 is in the second operating state or the blocked state, the control device 23 waits for a signal from the coding means 26. In this case, the signal from the coding means 26 may consist of a code which is input, in particular, by operating personnel to an input apparatus 27 of the coding means 26. If the control device 23 receives a signal from the coding means 26, in particular a code, the control device 23 first of all determines in a second step whether the signal received from the coding means 26 is the enable signal or the enable code or whether the signal received from the coding means 26 is the blocking signal or the blocking code. If the received signal is not the enable code or the enable signal, the control device 23 does not establish the first operating state of the delivery regulation device 19, with the result that the latter remains in the second operating state or the blocked state. If, in contrast, the enable signal is present, the control device 23 checks whether there is a regulation signal which is transmitted, for example, to the control device 23 in the form of a radio signal 38 from a control centre 29 and from the regulation signal receiving device 28 of the energy supply apparatus 10.

If the regulation signal is not present, the control device 23 does not establish the first operating state of the delivery regulation device 19, with the result that the latter still remains in the second operating state or the blocked state. If, in contrast, the regulation signal is present, the control device 23 establishes the first operating state of the delivery regulation device 19, with the result that the delivery regulation device 19 changes to the enabled state and uses the regulation means 20 to make it possible to transmit thermal energy in the form of heating water from the second energy generation unit 13 to a shore-based consumer by means of the coupling device 22.

If the delivery regulation device 19 is now in the first operating state or the enabled state, the control device 23 again waits for the reception of a signal or a blocking signal or a blocking code from the coding means 26. If a signal from the coding means 26 is received by the control device 23, the control device 23 checks whether the signal is the blocking signal or the blocking code or is the enable signal or the enable code. If the signal is the blocking signal, the control device 23 changes the delivery regulation device 19 to the second operating state, with the result that said delivery regulation device switches to the blocked state and prevents thermal energy from being delivered via the coupling device 22 by blocking the regulation means 20.

If, in contrast, there is no blocking signal, the control device 23 checks whether the regulation signal from the control centre 29 is still received by the regulation signal receiving device 28 and is forwarded to the control device 23. If the regulation signal is present, the control device 23 does not change the operating state of the delivery regulation device 19 and the delivery regulation device 19 remains in the first operating state or the enabled state, with the result that thermal energy in the form of heating water can still be delivered to a shore-based consumer via the coupling device 22.

If, in contrast, there is no regulation signal, the control device 23 changes the delivery regulation device 19 to the second operating state, with the result that the delivery regulation device 19 changes to the blocked state. In the blocked state, the regulation means 20 are blocked, with the result that thermal energy is prevented from being transmitted from the second energy generation unit 13 of the energy supply apparatus 10 to a shore-based consumer of thermal energy.

In the control method, provision may also be made for the control device 23 to check the presence of the regulation signal at regular intervals without the need for the reception of an enable or blocking signal from the coding means 26. As a result, the control centre 29 can already prevent the transmission of thermal energy to a consumer if disturbances occur in the operating sequence which are not transmitted to the control device 23 on the basis of sensor data from the sensor device 25 or as a result of an input by the operating personnel.

It is also possible to provide for the regulation signal to have to be received within a particular predetermined period between the reception of the enable code and the blocking code in method steps 2. and 5. This makes it possible to compensate for short-term interruptions in the connection to the control centre 29, for example. It is thus possible to predetermine, for example, that a period of 10 seconds to 30 seconds can elapse after receiving the enable code or the enable signal before the regulation signal must be present. The second operating state or the blocked state of the delivery regulation device 19 is established by the control device 23 only after the corresponding period has elapsed and the regulation signal is absent.

Furthermore, it is also possible to respectively swap the order in which the signal transmitted to the control device 23 by the coding means 26 is checked for an enable signal and a blocking signal and the presence of the regulation signal is checked in method steps 2. and 3. and method steps 5. and 6., respectively, with the result that the presence of the regulation signal is first of all checked and only then is the signal received from the coding means 26 checked in order to determine whether it is an enable signal or a blocking signal. In this case too, provision may be made for the regulation signal to be checked at regular intervals, a predetermined period of 10 to 30 seconds, for example, lying between the checking times. That is to say, in particular, the control device 23 decides, only after the predetermined period has elapsed, whether the delivery regulation device 19 is intended to be blocked or enabled.

### LIST OF REFERENCE SYMBOLS

100 Buoyant energy supply apparatus
10 Energy supply apparatus
11 Barge
12 First energy generation unit
13 Second energy generation unit
14 Internal combustion engine
15 Drive shaft
16 Generator
17 Exhaust gas line
18 Power-heat coupling device
19 Delivery regulation device
20 Regulation means
21 Heating water line
22 Coupling device
23 Control device
24 Control lines
25 Sensor device
26 Coding means
27 Input apparatus
28 Regulation signal receiving device
29 Control centre
30 Body of water
31 Shore boundary
32 Pipeline
33 Coupling device
34 District heating network
35 Forwarding device
36 Power line
37 Feed apparatus
38 Radio signal
39 Ship
40 Connection device

1. Apparatus for generating energy, comprising:
a first energy generation unit for generating electrical energy, in particular power; and
a second energy generation unit for generating thermal energy, in particular heat and/or cold; and
a delivery device for delivering the thermal energy generated by the second energy generation unit to a consumer and a delivery regulation device, the delivery regulation device being designed to enable the delivery device in a first operating state and to block the delivery device in a second operating state, wherein the delivery regulation device comprises regulation means, in particular mechanical blocking means and/or electrical blocking means and/or electromechanical blocking means and/or pneumatic blocking means and/or hydraulic blocking means, for enabling and blocking the delivery device; and/or
a control device for controlling the second energy generation unit, the control device being designed to activate the second energy generation unit in a first operating state and to block the second energy generation unit in a second operating state.

2. (canceled)

3. Apparatus according to claim 1, wherein the first energy generation unit and the second energy generation unit are coupled to one another for the purpose of transmitting energy between the two energy generation units.

4. (canceled)

5. Apparatus according to claim 1, wherein the regulation means comprise one or more components from the group of valves, bypass lines, shut-off means, in particular shut-off valves, shut-off flaps or ball valves.

6. Apparatus according to claim 1, wherein the apparatus comprises coding means for inputting a code, the first operating state being set by inputting a predetermined first code to the coding means and the second operating state being set by inputting a predetermined second code to the coding means.

7. Apparatus according to claim 6, wherein the second operating state is set as soon as the input of the first code is a predetermined period in the past.

8. Apparatus according to claim 14, wherein the apparatus comprises a control device which controls the regulation means in such a manner that the regulation means enable the delivery device for the purpose of delivering the thermal energy in the first operating state and block the delivery device in the second operating state.

9. Apparatus according to claim 8, wherein the apparatus comprises coding means for inputting a code, the first operating state being set by inputting a predetermined first code to the coding means and the second operating state being set by inputting a predetermined second code to the coding means, and wherein the coding means are designed to transmit an enable signal to the control device when the predetermined first code is input and/or are designed to transmit a blocking signal to the control device when the predetermined second code is input, the control device controlling the delivery regulating means, in particular, only after receiving the enable signal for enabling the delivery device for the purpose of delivering the thermal energy.

10. Apparatus according to claim 8, wherein input apparatus for inputting commands to the control device by a user is provided, the input device being in wired or wireless data communication with the control device, and the input device preferably being arranged in a manner remote from the second energy generation unit.

11. Apparatus according to claim 8, wherein the apparatus has a sensor device for determining particular parameters of the apparatus or components of the apparatus or measurement data, the sensor device being designed to transmit the determined parameters or measurement data to the control device, and the control device being designed to determine and/or set the operating state on the basis of the transmitted parameters or measurement data.

12. Apparatus according to claim 8, wherein the apparatus comprises a regulation signal receiving device for receiving a superordinate regulation signal, the first or second operating state being assumed, irrespective of further specifications or signals relating to the operating state, only when the regulation signal receiving device receives or does not receive a regulation signal, wherein the regulation signal receiving device is in data communication with the control device and controls the regulation means on the basis of the presence or absence of a regulation signal.

13. (canceled)

14. Apparatus according to claim 12, wherein the regulation signal is received by the regulation signal receiving device if one or more conditions of the following group are satisfied: manual enabling carried out by authorized operating personnel situated at the apparatus or spatially remote from the apparatus, emission of the regulation signal by a control centre spatially remote from the apparatus, establishment of a connection between the delivery device and a consumer, in particular a preferably predetermined shore-based consumer, identification of a consumer coupled to the delivery device as the predetermined consumer, exceeding or undershooting of a predefined spatial distance between the apparatus and a predetermined reference point, residence or non-residence of the apparatus in a predetermined spatial region.

15. Apparatus according to claim 12, wherein the second operating state is set as soon as the regulation signal receiving device does not receive a regulation signal within a predetermined period of time.

16. Apparatus according to claim 1, wherein the first energy generation unit and the second energy generation unit each comprise one or more components from the group of an internal combustion engine, a generator, a fuel cell, a device for using solar energy, such as a solar cell or a photovoltaic cell, a tidal power plant, a wave power plant, a hydroelectric power plant, a wind power plant, a biomass power plant, a device for using gaseous expansion pressures, a device for using stored energy, a device for thermally using the ground, a power-heat coupling device, preferably a heat exchanger, particularly preferably an exhaust gas heat exchanger, a power-heat-cold coupling device, in particular an absorption chiller, means for storing electrical energy, means for storing thermal energy.

17. Apparatus according to claim 16, wherein the first energy generation unit comprises an internal combustion engine and a generator coupled to the internal combustion engine, and in that the second energy generation unit comprises a power-heat coupling device and/or a power-heat-cold coupling device for generating thermal energy using the waste heat, in particular the waste heat of the exhaust gases, of the internal combustion engine of the first energy generation unit.

18. (canceled)

19. Apparatus according to claim 1, wherein the apparatus comprises a forwarding device for forwarding the electrical energy generated by the first energy generation unit to a consumer and a forwarding regulation device, the forwarding regulation device being designed to enable the forwarding device of the first energy generation unit in a third operating state and to block the forwarding device in a fourth operating state, wherein in particular the third or fourth operating state respectively being assigned to the first or second operating state.

20. (canceled)

21. Buoyant energy supply apparatus, comprising a buoyant supporting body, in particular a watercraft, and an apparatus for generating energy, said apparatus for generating energy comprising
a first energy generation unit for generating electrical enemy, in particular power;
a second energy generation unit for generating thermal energy, in particular heat and/or cold;
a delivery device for delivering the thermal energy generated by the second energy generation unit to a consumer and a delivery regulation device, the delivery regulation device being designed to enable the delivery device in a first operating state and to block the deliver device in a second operating state, wherein the delivery regulation device comprises regulation means, in particular mechanical blocking means and/or electrical blocking means and/or electromechanical blocking means and/or pneumatic blocking means and/or hydraulic blocking means, for enabling and blocking the delivery device; and/or
a control device for controlling the second energy generation unit, the control device being designed to activate the second energy generation unit in a first operating state and to block the second energy generation unit in a second operating state; wherein the apparatus is arranged on the buoyant supporting body.

22. Buoyant energy supply apparatus according to claim 21, wherein the first energy generation unit comprises a forwarding device for forwarding the generated electrical energy to a consumer, the forwarding device for feeding power from the apparatus into a consumer on the watercraft and/or into a shore-based consumer being designed both for connection to a consumer on a watercraft, preferably an on-board power supply system, and for connection to a shore-based consumer, preferably a shore-based power supply system, and the delivery device being designed for connection to a shore-based consumer, preferably a district heating network, for the purpose of feeding heated fluid from the apparatus into the shore-based consumer.

23. System comprising a buoyant energy supply apparatus,
said buoyant energy supply apparatus comprising a buoyant supporting body, in particular a watercraft, and an apparatus for generating energy, said apparatus for generating energy comprising:
a first energy generation unit for generating electrical energy, in particular power;
a second energy generation unit for generating thermal energy, in particular heat and/or cold;
a deliver device for delivering the thermal energy generated by the second energy generation unit to a consumer and a delivery regulation device, the delivery regulation device being designed to enable the delivery device in a first operating state and to block the delivery device in a second operating state, wherein the delivery regulation device comprises regulation means, in particular mechanical blocking means and/or electrical blocking means and/or electromechanical blocking means and/or pneumatic blocking means and/or hydraulic blocking means, for enabling and blocking the delivery device; and/or
a control device for controlling the second energy generation unit, the control device being designed to activate the second energy generation unit in a first operating state and to block the second energy generation unit in a second operating state,
wherein the apparatus is arranged on the buoyant supporting body,
wherein the system further comprises a shore-based consumer for electrical energy, preferably a shore-based power supply system, and a watercraft comprising a consumer for electrical energy on the watercraft, in particular an on-board power supply system, the buoyant energy supply apparatus feeding electrical energy generated by the first energy generation unit into the shore-based consumer for electrical energy in the first operating state, and the buoyant energy supply apparatus feeding electrical energy generated by the first energy generation unit into the consumer for electrical energy on the watercraft in the second operating state.

24. System according to claim 23, wherein the system comprises a shore-based consumer for thermal energy, in particular a shore-based district heating network, and wherein the buoyant energy supply apparatus feeds thermal energy generated by the second energy generation unit into the shore-based consumer for thermal energy in the first operating state.

25. System comprising a buoyant energy supply apparatus said buoyant energy supply apparatus comprising a buoyant supporting body, in particular a watercraft, and an apparatus for generating energy, said apparatus for generating energy comprising
a first energy generation unit for generating electrical energy, in particular power, and
a second energy generation unit for generation thermal energy, in particular heat and/or cold, and
a delivery device for delivering the thermal energy generated by the second energy generation unit to a consumer and a delivery regulation device, the delivery regulation device being designed to enable the delivery device in a first operating state and to block the delivery device in a second operating state, wherein the delivery regulation device comprises regulation means, in particular mechanical blocking means and/or electrical blocking means and/or electromechanical blocking means and/or pneumatic blocking means and/or hydraulic blocking means, for enabling and blocking the delivery device, and/or
a control device for controlling the second energy generation unit, the control device being designed to activate the second energy generation unit in a first operating state and to block the second energy generation unit in a second operating state,
wherein the apparatus is arranged on the buoyant supporting body,
wherein the system further comprises a predetermined consumer arranged outside the buoyant energy supply apparatus for the thermal energy generated by the second energy generation unit, the apparatus for generating energy of the buoyant energy supply apparatus comprising a forwarding device for forwarding the thermal energy generated by the second energy generation unit to the consumer, the consumer comprising a means of identification, the buoyant energy supply apparatus being set up to detect the means of identification, in which case, only if the means of identification is detected by the buoyant energy supply apparatus,
the delivery regulation device is designed to enable the delivery device, and/or
the control device for controlling the second energy generation unit is designed to activate the second energy generation unit, and/or
an acceptance blocking apparatus of the consumer is designed to accept the thermal energy forwarded to the consumer by the forwarding apparatus of the buoyant supply device, and/or
a forwarding regulation device of the forwarding device is designed to enable the forwarding device.

26. System according to claim 25, wherein the consumer comprises a coupling device for connecting the forwarding device to the consumer, the acceptance blocking apparatus being arranged on the coupling device.

27. System according to claim 25, wherein the acceptance blocking apparatus and/or the forwarding regulation device each comprise a detachably arranged identifier means, the identifier means each being enabled for removal only when the acceptance blocking apparatus and the forwarding regulation device are in the enabling state, and wherein the delivery regulation device enables the delivery device only when the identifier means are enabled and/or are supplied to the delivery regulation device, the means of identification comprising the identifier means of the acceptance blocking apparatus, in particular.

28. System according to claim 25, wherein an identifier means storage device is provided and contains a further identifier means for being supplied to and for enabling the delivery regulation device, the identifier means storage device being designed to receive the identifier means of the acceptance blocking apparatus and/or the forwarding device and to enable the further identifier means when the identifier means of the acceptance blocking apparatus and/or the forwarding device is received.

29. Method for supplying a predetermined consumer with thermal energy using a system comprising a buoyant energy supply apparatus, said buoyant energy supply apparatus comprising a buoyant supporting body, in particular a watercraft, and an apparatus for generating energy, said apparatus for generating energy comprising:
a first energy generation unit for generating electrical energy, in particular power;
a second energy generation unit generating thermal energy, in particular heat and/or cold;
a delivery device for delivering the thermal energy generated by the second energy generation unit to a consumer and a delivery regulation device, the delivery regulation device being designed to enable the delivery device in a first operating state and to block the delivery device in a second operating state, wherein the delivery regulation device comprises regulation means, in particular mechanical blocking means and/or electrical blocking means and/or electromechanical blocking means and/or pneumatic blocking means and/or hydraulic blocking means, for enabling and blocking the delivery device; and/or
a control device for controlling the second energy generation unit, the control device being designed to activate the second energy generation unit in a first operating state and to block the second energy generation unit in a second operating state;
wherein the apparatus is arranged on the buoyant supporting body; and
wherein said system further comprises a predetermined consumer arranged outside the buoyant energy supply apparatus for the thermal energy generated by the second energy generation unit, characterized by the following steps:
the delivery of thermal energy generated by the second energy generation device to consumers is blocked;
a means of identification of the predetermined consumer is detected by the buoyant energy supply apparatus;
a forwarding device for forwarding the thermal energy generated by the second energy generation unit to the predetermined consumer is connected;
the delivery of thermal energy generated by the second energy generation device to the predetermined consumer is enabled; and
the thermal energy generated by the second energy generation device is delivered to the predetermined consumer by the buoyant energy supply apparatus.

30. Method according to claim 29, wherein the buoyant energy supply apparatus checks, in particular continuously, whether the means of identification of the predetermined consumer is still present, the delivery of thermal energy generated by the second energy generation device to consumers being blocked as soon as the check reveals that the means of identification is no longer present.

31. Method according to claim 29, wherein the means of identification comprises a detachably arranged identifier means, a further, detachably arranged identifier means preferably being provided in the region in which the forwarding apparatus is connected to the buoyant energy supply apparatus, the identifier means being designed in such a manner that they can be removed only after the forwarding device has been connected to the predetermined consumer and/or to the buoyant supply device, the following steps being carried out:
the identifier means are removed after the forwarding device has been connected to the predetermined consumer and/or to the buoyant energy supply apparatus, and
the identifier means are supplied to the delivery regulation device, or
the identifier means are supplied to an identifier means storage device, a further identifier means arranged in the identifier means storage device being enabled as a result of the identifier means being supplied, the further identifier means then being supplied to the delivery regulation device.

32. Method for supplying consumers with electrical energy and with thermal energy using an apparatus for generating energy, comprising a first energy generation unit for generating electrical energy, in particular power, and a second energy generation unit for generating thermal energy, in particular heat and/or cold in which an operating state of the apparatus or of a component of the apparatus is determined and/or set, electrical energy generated using the first energy generation unit being fed into a shore-based consumer for electrical energy, in particular a shore-based power supply system, and thermal energy generated using the second energy generation unit being fed into a shore-based consumer for thermal energy, in particular a shore-based district heating network, when a first operating state is determined and/or set, and electrical energy generated using the first energy generation unit being fed into a consumer for electrical energy on a watercraft, in particular an onboard power supply system of a watercraft, and the delivery of thermal energy generated using the second energy generation unit to consumers being blocked at the same time, when a second operating state is determined and/or set.

33. (canceled)

34. Method according to claim 32, wherein the apparatus is arranged on a buoyant supporting body thus forming of a buoyant energy supply apparatus, the buoyant energy supply apparatus being moored to land or situated on land in the first operating state and the delivery of thermal energy generated using the second energy generation unit to consumers being blocked as soon as the buoyant energy supply apparatus leaves land.
